(19) United States
(12) Patent Application Publication
(10) Pub. No.: US 2011/0131725 A1
(43) Pub. Date: Jun. 9, 2011

(54) PATIENT SUPPORT SYSTEM WITH MODULAR INTEGRATED FLUID SUPPLY SYSTEM

(75) Inventors: Glenn Stroh, Marion, TX (US); John Vrzalik, San Antonio, TX (US); Cesar Z. Lina, Universal City, TX (US)

(73) Assignee: KCI LICENSING, INC., San Antonio, TX (US)

(21) Appl. No.: 12/961,717

(22) Filed: Dec. 7, 2010

Related U.S. Application Data
(60) Provisional application No. 61/267,901, filed on Dec. 9, 2009.

(51) Int. Cl. A61G 7/057; A61G 7/00; A61G 7/047; B65B 3/04

(52) U.S. Cl. 5/600; 141/1

(57) ABSTRACT

A system and method for providing a fluid pressure supply system releasably coupled to a docking station of a patient support system. One or more coupling members can provide fluid communication between the fluid pressure supply source and a patient support member of the patient support system.

### CROSS-REFERENCE TO RELATED APPLICATIONS

This application claims priority to U.S. Provisional Patent Application Ser. No. 61/267,901 (filed Dec. 9, 2009), incorporated by reference herein.

### BACKGROUND INFORMATION

The formation of pressure ulcers, also commonly referred to as bedsores, is an ongoing and costly issue in health care worldwide. Ischemia to soft tissues is a major contributor to the formation of pressure ulcers. The compression of the various tissues between a boney prominence of an individual and the support surface they are sitting or lying upon can lead to cell death if the pressure is high over a very short period of time (e.g., sometimes in 1-2 hours) or lower pressures are experienced over a more chronic, extended period of time. Excessive moisture vapor at the patient-support interface can also lead to pressure ulcers.

It is therefore often desirable to incorporate a fluid supply system into a patient support apparatus. A fluid (e.g., air) supply system may be utilized to inflate or deflate portions of a patient support apparatus to change the support locations underneath a patient. A fluid supply system may also be used to assist in moisture vapor reduction at the interface between the patient and the patient support.

Typical fluid supply systems often comprise components located underneath the patient support surface and/or include external hoses and connections to the patient support member (e.g., mattress or coverlet). Such systems can create ergonomic issues and make it more difficult for a nurse or health care provider to access the patient. In addition, access to the components of the fluid supply system can be difficult when they are incorporated underneath the patient support member. This can make maintenance of such systems and components more difficult.

Systems and methods which address these issues would be of benefit to the medical community.

### SUMMARY

Embodiments of the present disclosure include systems and methods for providing a fluid pressure supply system releasably coupled to a docking station of a patient support system. In exemplary embodiments, coupling members in the docking station and fluid supply system can provide fluid communication between a fluid pressure supply source and a patient support member. In specific embodiments, the coupling members are automatically coupled when the fluid supply system is docked in the docking station.

Particular embodiments include a patient support system comprising: a patient support member; a frame; a fluid supply system comprising a housing, a fluid pressure supply source, and a first coupling member; and a docking station configured to releasably couple to the fluid supply system, wherein the docking station comprises a second coupling member configured to couple to the first coupling member and provide fluid communication between the fluid pressure supply source and the patient support member.

In certain embodiments, the fluid pressure supply source comprises a fan. Particular embodiments may also comprise a footboard. In certain embodiments, the docking station is integrated into the footboard. In specific embodiments, the fluid supply system and docking station comprise electrical coupling members. In certain embodiments, the fluid supply system housing comprises a handle configured to allow a user to remove the fluid supply system from the docking station. In specific embodiments, the fluid supply system housing comprises a control panel.

Particular embodiments may further comprise a first conduit between the fluid pressure supply source and the first coupling member. Certain embodiments may comprise a valve in the first conduit. Specific embodiments may comprise a second conduit between the second coupling member and the patient support member. In particular embodiments, the second conduit is integrated with the frame. In certain embodiments, the fluid supply system comprises an electrical power distribution system, a microcontroller and/or retention members.

Particular embodiments may include a method of providing fluid to a patient support member, the method comprising: providing a patient support system as described herein; coupling the fluid supply system to the docking station; and operating the fluid supply system to provide fluid to the patient support member.

### BRIEF DESCRIPTION OF THE FIGURES

While exemplary embodiments of the present invention have been shown and described in detail below, it will be clear to the person skilled in the art that changes and modifications may be made without departing from the scope of the invention. As such, that which is set forth in the following description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention.

In the following Detailed Description of Exemplary Embodiments, various features are grouped together in several embodiments for the purpose of streamlining the disclosure. This method of disclosure is not to be interpreted as reflecting an intention that exemplary embodiments of the invention require more features than are expressly recited in each claim. Rather, as the following claims reflect, inventive subject matter lies in less than all features of a single disclosed embodiment. Thus, the following claims are hereby incorporated into the Detailed Description of Exemplary Embodiments, with each claim standing on its own as a separate embodiment.

FIG. 1 is a perspective view of one non-limiting, exemplary embodiment of a patient support system comprising a docking station and a fluid supply system.

FIG. 2 is a perspective view of the docking station and fluid supply system of the embodiment of FIG. 1 in a first coupled position.

FIG. 3 is a perspective view of the docking station and fluid supply system of the embodiment of FIG. 1 in a second partially de-coupled position.

FIG. 4 is a perspective view of the docking station and fluid supply system of the embodiment of FIG. 1 in a third completely de-coupled position

FIG. 5 is an orthographic view of the fluid supply system of FIG. 1.

### DETAILED DESCRIPTION OF EXEMPLARY EMBODIMENTS

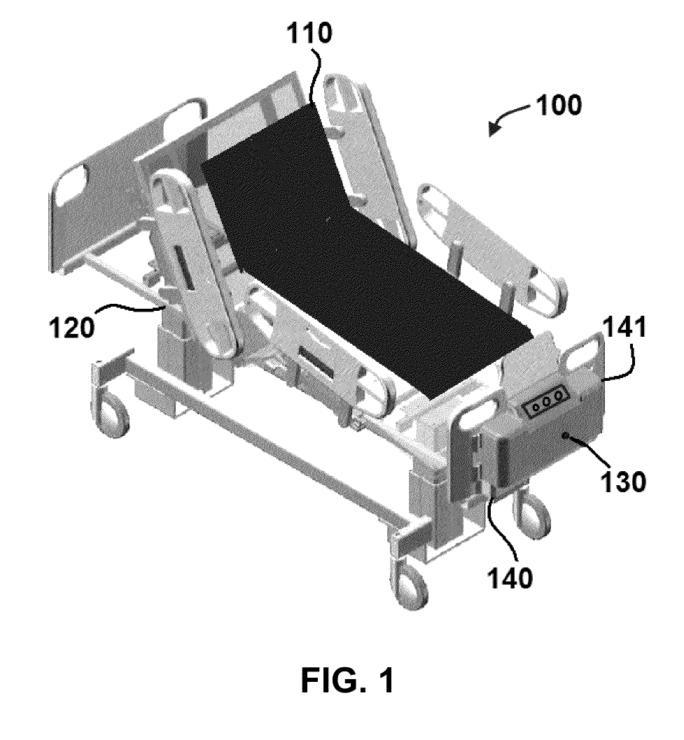

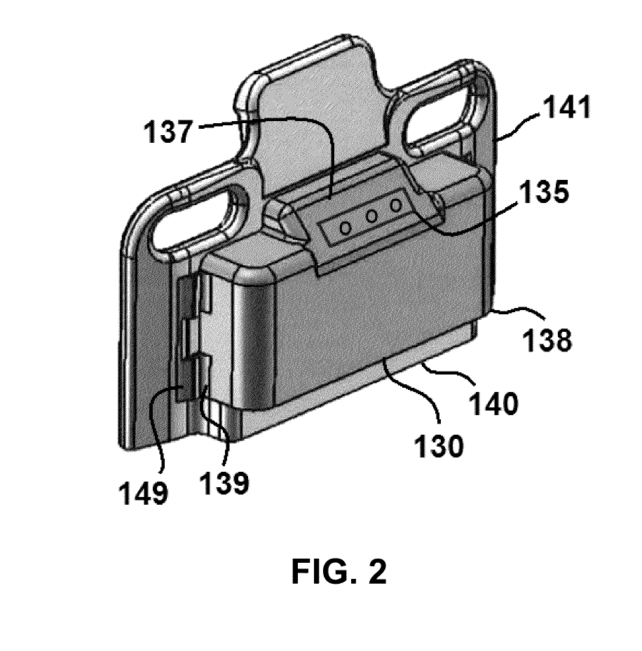

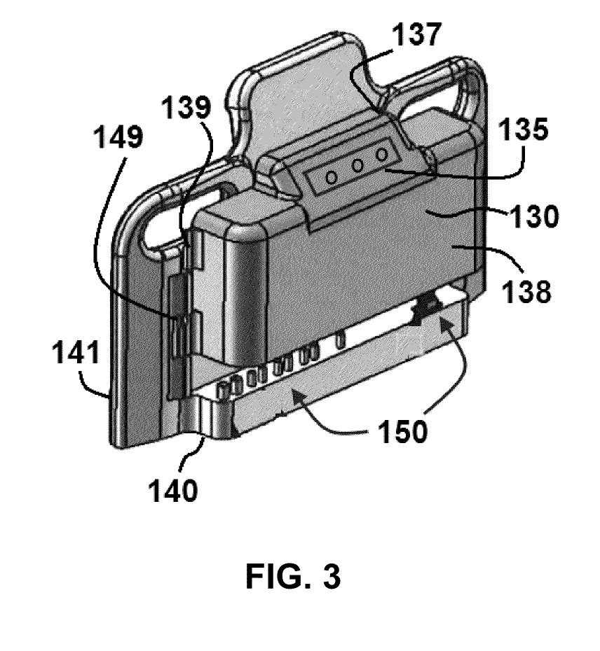

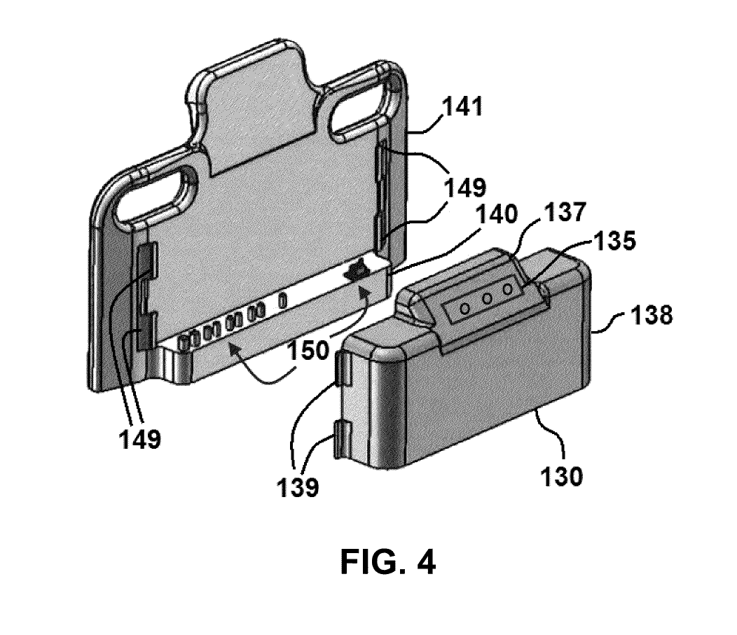

Referring initially to the exemplary embodiment shown in FIG. 1, a patient support system 100 comprises a patient support member 110, a frame 120, a fluid supply system 130, and a docking station 140 configured to releasably couple to fluid supply system 130. FIGS. 2-5 illustrate more detailed views of docking station 140 and/or fluid supply system 130 in order to provide a closer view of specific features.

In exemplary embodiments, patient support member 110 may comprise any member configured to be placed under a patient. Non-limiting examples of patient support members include mattresses, as well as coverlets configured to be placed between a mattress and a patient. In specific embodiments, a patient support member may comprise a mattress with inflatable air cells. Exemplary embodiments may also comprise a patient support configured as a coverlet that provides for reduced moisture vapor levels at the patient-support interface.

In the illustrated exemplary embodiments, fluid supply system 130 is configured to be releasably coupled to docking station 140. In this particular embodiment, docking station 140 is integrated into a footboard 141 of patient support system 100. It is understood that in other embodiments, docking station 140 may be incorporated into other components of patient support system, including, for example, the headboard, frame or side rails.

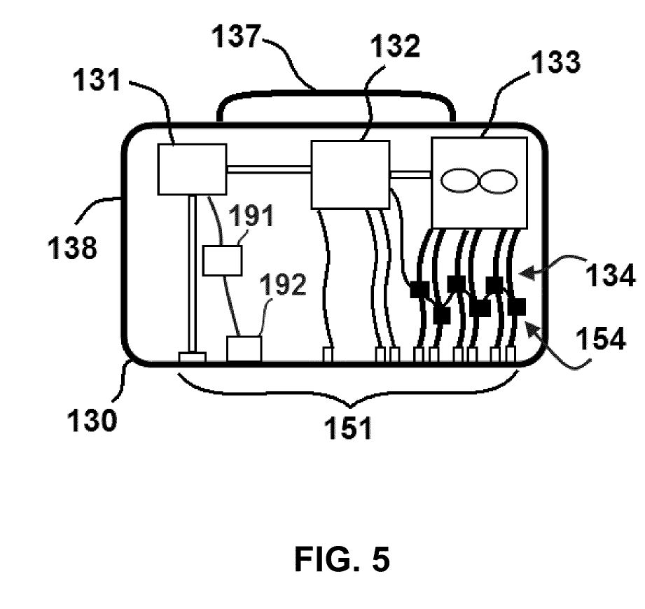

In the exemplary embodiment shown, fluid supply system 130 comprises a housing 138 with a handle 137 (or other member configured for gripping by a user) that allows fluid supply system 130 to be separated (e.g., de-coupled) from docking station 140. The illustrated exemplary embodiment of fluid supply system 130 may also comprise an electrical power distribution system 131, a microcontroller 132, a fluid pressure supply source 133, and a plurality of coupling members 151. In particular embodiments, fluid pressure supply source 133 may comprise a fan or blower or other suitable air mover. While fluid pressure supply source 133 is shown within housing 138 in FIG. 5, in other embodiments fluid supply pressue source 133 may be external to housing 138. In certain embodiments, electrical power distribution system 131 may comprise a transformer or other components configured to distribute electrical power from electrical coupling members 150, 151 to microcontroller 132 and/or fluid pressure supply source 133.

In certain embodiments, fluid supply system 130 may comprise an alternating current-to-direct current (AC-DC) converter 191 to provide direct current to other components, including for example, an air mover configured to provide air flow to a coverlet. In specific embodiments, a current sensor 192 may be incorporated to detect the amount of current being drawn from the components coupled to AC-DC converter 191. In particular embodiments, current sensor 192 may be used to detect if an air mover is functioning and providing a desired amount of air flow.

In the exemplary embodiment shown, fluid pressure supply source 133 is in fluid communication with coupling members 151 via a series of conduits 134. In addition, a plurality of valves 154 (or other flow control members) may be located within fluid supply system 130. Microcontroller 132 can be electrically coupled to valves 154 to control the fluid pressure and/or flow supplied to coupling members 151. It is understood that this listing of components is merely exemplary, and that other exemplary fluid supply systems may comprise a different combination of components. For example, microcontroller 132 and/or valves 154 may be located outside of housing 138 (e.g., within frame 120 or proximal to frame 120).

In certain embodiments, housing 138 may comprise a control panel 135 configured to allow a user to control parameters of fluid supply system 130. As explained in more detail below, fluid supply system 130 is configured to provide fluid (e.g., air) to patient support member 110.

In the exemplary embodiment shown, docking station 140 comprises a plurality of coupling members 150 configured to couple with coupling members 151 of fluid supply system 130. In certain embodiments, one or more coupling members 150 and 151 can be configured to provide fluid communication between fluid pressure supply source 133 and patient support member 110. A portion of coupling members 150 and 151 may also be configured to provide electrical power connections and control connections (e.g. electrical or pneumatic) to control parameters such as fluid pressure or flow. In the embodiment shown, coupling members 150 and 151 are configured so that they may be automatically coupled when fluid supply system 130 is docked into docking station 140 (e.g., coupling members 150 and 151 are coupled when fluid supply system 130 is docked without additional action required by a user).

In exemplary embodiments, a portion of coupling members 150 are in fluid communication with fluid pressure transfer members (e.g., conduits) that allow the fluid pressure to be distributed to patient support member 110. In specific embodiments, the fluid pressure transfer members are integrated into frame 120. During operation, microcontroller 132 can open and close valves 154, thereby controlling the fluid pressure supply to patient support member 110 or to specific regions of patient support member 110.

In certain embodiments, the fluid pressure supply can be increased to a first portion of patient support member 110 while the fluid pressure supply is reduced to a second portion of patient support member 110. This can allow alternating pressures to be supplied to the patient support surface, which can supply alternating support pressure for the patient, percussion therapy, and/or turning of the patient. This can reduce the likelihood that a patient will develop complications, including for example, pressure sores, pulmonary complications, blood clots, and other complications of immobile patients.

In particular embodiments, the fluid pressure and/or flow may be provided to a patient support member configured as a coverlet that is configured to reduce moisture vapor at the interface between the patient and the patient support. In specific embodiments, the fluid (e.g., air) may be provided to a spacer material in a coverlet placed underneath a patient. In certain embodiments, the fluid supplied to the coverlet may be provided at either a positive or negative pressure.

In certain exemplary embodiments, the amount of air flow needed for effective moisture vapor transfer in a coverlet is reduced when compared to traditional low air loss mattresses. This can allow fluid pressure supply source 133 to be smaller than fluid pressure supply sources associated with typical low air loss mattresses. Such a reduction in size can provide a smaller profile for housing 138 of fluid pressure supply system 130, and allow for easier docking of fluid pressure supply system 130.

In the illustrated embodiment, docking station 140 and fluid supply system 130 comprise retention members 149 and 139, respectively. Retention members 149, 139 are configured to retain fluid supply system 130 when fluid supply system 130 is docked in docking station 140. In specific embodiments, retention members 149, 139 may include a sliding engagement. In particular embodiments, retention members 149, 139 may comprise latching members configured to secure engagement of fluid pressure supply system 130 with docking station 140. In the illustrated embodiment, fluid supply system 130 can be removed from docking station 140 by gripping handle 137 and pulling fluid supply system 130 away from docking station 140.

Incorporating components of fluid supply system 130 into a modular unit such as housing 138, which couples with docking station 140, can provide numerous advantages over other designs. The fluid supply system 130 can be compactly arranged and allow for a more ergonomic design. For example, by eliminating the need for external hoses or connections, a nurse or health care provider can have improved access to a patient supported by patient support member 110. In addition, the modular design of fluid supply system 130 allows for convenient replacement of components for maintenance or testing. It is understood that the described advantages are merely exemplary, and that other benefits may be provided by the disclosed design.

1. A patient support system comprising:
a patient support member;
a frame;
a fluid supply system comprising a housing, a fluid pressure supply source, and a first coupling member; and
a docking station configured to releasably couple to the fluid supply system, wherein the docking station comprises a second coupling member configured to couple to the first coupling member and provide fluid communication between the fluid pressure supply source and the patient support member.

2. The patient support system of claim 1 wherein the fluid pressure supply source is selected from the group consisting of a fan, an air blower, and an air pump.

3. The patient support system of claim 1 wherein the fluid pressure supply is configured to supply positive or negative air pressure to the patient support member.

4. The patient support system of claim 1, further comprising a footboard and wherein the docking station is integrated into the footboard.

5. The patient support system of claim 1, wherein the fluid supply system and docking station comprise electrical coupling members.

6. The patient support system of claim 1 wherein the fluid supply system housing comprises a handle configured to allow a user to remove the fluid supply system from the docking station.

7. The patient support system of claim 1 wherein the fluid supply system housing comprises a control panel.

8. The patient support system of claim 1, further comprising a first conduit between the fluid pressure supply source and the first coupling member.

9. The patient support system of claim 8, further comprising a valve in the first conduit.

10. The patient support system of claim 1, further comprising a second conduit between the second coupling member and the patient support member.

11. The patient support system of claim 10 wherein the second conduit is integrated with the frame.

12. The patient support system of claim 1 wherein the fluid supply system comprises an electrical power distribution system.

13. The patient support system of claim 1 wherein the fluid supply system comprises a microcontroller.

14. The patient support system of claim 1 wherein the fluid supply system and the docking station comprise retention members.

15. The patient support system of claim 1 wherein the fluid supply system comprises an alternating current-to-direct current (AC-DC) converter.

16. The patient support system of claim 15 wherein the fluid supply system comprises an current sensor coupled to the alternating current-to-direct current (AC-DC) converter.

17. A method of providing fluid to a patient support member, the method comprising:
providing a patient support system comprising:
a frame;
a fluid supply system comprising a housing, a fluid pressure supply source, and a first coupling member; and
a docking station configured to releasably couple to the fluid supply system, wherein the docking station comprises a second coupling member configured to couple to the first coupling member and provide fluid communication between the fluid pressure supply source and the patient support member;
coupling the fluid supply system to the docking station; and
operating the fluid supply system to provide fluid to the patient support member.

18. The method of claim 17 wherein the patient support system comprises a footboard and wherein the docking station is integrated into the footboard.

19. The method of claim 17 wherein the fluid supply system comprises a microcontroller and a valve, and wherein operating the fluid supply system to provide fluid to the patient support member comprises opening and closing the valve.

20. The method of claim 17 wherein the first coupling member is automatically coupled to the second coupling member when the fluid supply system is coupled with the docking station.

21. The method of claim 17 wherein the fluid supply system and the docking station each comprise retention members and wherein coupling the fluid supply system to the docking station comprises slidably engaging the retention members member of the docking station with the retention members of the fluid supply system.

22. The method of claim 17 wherein the fluid supply system comprises a third coupling member and the docking station comprises a fourth coupling member, and wherein the third and fourth coupling members are configured to provide an electrical connection between the fluid supply system and the docking station.
